(19) United States
(12) Patent Application Publication
(10) Pub. No.: US 2009/0199925 A1
(43) Pub. Date: Aug. 13, 2009

(54) Systems and Methods for Exhausting Vapors from a Tank

(76) Inventor: David D. Russell, Blodgett, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/019,255

(22) Filed: Jan. 24, 2008

Related U.S. Application Data
(60) Provisional application No. 60/886,358, filed on Jan. 24, 2007.

(51) Int. Cl. B67D 5/00; B65B 31/04

(52) U.S. Cl. 141/4; 141/66

(57) ABSTRACT

This invention relates to an apparatus and a method of making and using the apparatus to remove vapors from a storage tank, particularly an underground storage tank. In particular, the apparatus provides a combination of a pump and a stack capable of secure connection to a tank, through which combination vapors from the tank can be exhausted at the height of the stack.

### CROSS REFERENCE TO RELATED APPLICATION(S)

This application claims benefit of, and priority to, U.S. Provisional Application Ser. No.: 60/886,358, filed Jan. 24, 2007, the entire disclosure of which is herein incorporated by reference.

### BACKGROUND

1. Field of the Invention

This invention relates to an apparatus, and a method of making and using the apparatus, for removing vapors from a storage tank. In particular, the apparatus provides a combination of a pump and a chimney capable of secure connection to a tank, through which vapors can be removed from the tank and can be exhausted at a regulation height of 12 feet or more.

2. Description of the Related Art

Tanks from which vapors need to be exhausted are often underground or above ground storage tanks. Commercial and industrial liquids of all types are stored in such storage tanks. One of the most common uses for the underground variety, however, is the storage of automobile fuels at gas stations where the tanks provide for a measure of safety and are out of the way of fueling automobiles. The tanks are generally roughly cylindrical in shape and usually have a capacity in the range of 500 to 20,000 gallons or more. Such tanks are generally made of either metal (usually steel) or a fiber reinforced resinous material depending on the type of material they are designed to hold.

The use of underground storage tanks in fueling stations requires them to hold automotive fuels of various forms. This includes traditional gasoline, as well as diesel fuel, and more commonly now E-85 (Ethanol) or other biological matter based fuels. Such fuel storage is very dangerous due to the inherently flammable and explosive nature of the fuel. Further, such fuels, as well as many additives to such fuels, are toxic and bad for the environment if they get into soil or groundwater. Therefore, it is necessary to make sure that the fuel does not leach through the material of the storage tank, and that any potential leak in the storage tank is promptly detected and repaired. Leaking fuel tanks present a major environmental hazard.

Because the liquids stored in such tanks are often hazardous, and thus can cause severe environmental damage and greatly impact the lives of people living, working, and recreating in nearby areas, careful attention to the potential for leaks from such tanks is exercised. Due to these potential problems from leaks, safer storage tanks have been designed with a double wall, such that a breach in the integrity of either of the inner or outer wall alone will not allow a leak of the liquid contained in the tank to the environment. The use of such double-walled tanks (or equivalents thereof, wherein some sort of secondary containment is provided for an otherwise single-walled tank) is increasingly being mandated by government regulation.

In one alternative tank structure that provides added safety from the hazards of leaking storage tanks, a liner is installed in a tank that has been in use and is already in the ground. Certain of these liners can be installed without removing the tank from its underground position. Such a lining can be significantly more economical to install as compared with removal and replacement of the single-walled tank with a new double-walled tank. Further, new fuels (particularly ethanol) have created instances where existing tanks which are already installed were not produced of compatible material to be used with new fuels which the station now has to sell., These tanks then need to be updated by being lined, or may need to be removed and replaced.

Whether installing a liner, inspecting or repairing a tank, or preparing a tank for decommissioning, before a person can enter the tank to perform work on it, the tank needs to be safe to enter as many of these tasks are performed by personnel physically within the interior of the tank with the tank in place underground. Even if personnel are not physically within the tank, dangers can still present due to the conditions internal to the tank.

A large tank provides for an enclosed space. In the first instance, all the material stored in the tanks needs to be removed to allow personnel to access the tank interior without inadvertent spillage and to allow them to have access to the entire interior surface. However, even once the material is removed, there are often still residues of the material present. These can be removed by having the interior be mopped or otherwise cleaned to eliminate any remaining residue. However, even after this is completed, there often still remains concerns from vapors from the material being present. While vapors of a variety of materials can present a significant hazard to workers in or near the tank because they are poisonous or dangerous to breathe, vapors related to automotive fuels, which are extremely flammable, can present additional problems.

The removal of vapors from a tank is generally referred to as “vapor freeing” a tank. In the simplest procedure, a cap is removed from a tank opening and the vapors eventually exit the tank into the surrounding atmosphere as they dissipate with surrounding air. This procedure, however, is impractically time consuming, so that in nearly all instances, the vapor is forced out of the tank either by pushing it out with a positive pressure or pulling it out with a reduced pressure. Positive pressure removal generally requires the tank to be filled with something (often water) to force out the vapors. While this can be effective in some instances such as decommissioning, it is generally impractical where personnel will be inside the tank.

Instead, in these cases a reduced external pressure (a vacuum) is used. The pressure differential is generally generated by a pump of some sort, such as a blower, which is connected to the tank to pull the vaporous contents out of the tank prior to a person's entry into the tank. The percentage of vapor in the tank is monitored during the pumping to insure that entry is only made after the concentration of vapor is sufficiently low to not present an undue hazard.

At least in some jurisdictions, vapor freeing of an underground storage tank that was used to store automobile fuels when using a blower is required to include a procedure whereby the vapors from the tank are released into the atmosphere at least twelve feet above the ground. Gasoline vapors are highly explosive as they are what is utilized in combustion in the operation of an automotive engine. For this reason, an empty fuel storage tank can be particularly dangerous. While the liquid fuel has been removed, the tank can easily include a large amount of vapor from the time when the fluid was present, and also from that which may leach from the walls due to material which was absorbed. In a large tank, the vapor can result in a large explosion hazard where a stray spark could ignite the vapor inside the tank causing a massive explosion within the tank.

Releasing the vapor at a higher altitude above the tank helps to keep the vapor from resting at ground level where it may create pollution or settle as it can not as easily dissipate. The increased elevation also provides for distancing of the vapor release from activities on the ground where sparks or other fire hazards are more likely to exist lessening the explosion hazard.

In practical reality, many practitioners when preparing tanks fail to follow such a release procedure because it is difficult to have such a high altitude release with current technology. Blowers built to pull air from underground tanks are often only 3-4 feet tall when installed simply to provide for a reasonable sized device to use and transport. Therefore, many practitioners will release the fumes at this height, which often results in the fumes being released around head height of personnel, a particularly undesirable elevation.

In order to try and comply with the regulations, others use simple contraptions for an exhaust conduit for the vapor, such as a flexible plastic tube made from a very large plastic bag that is simply taped or otherwise haphazardly attached to the blower. Numerous problems exist with such make-shift approaches. In addition to not necessarily being effective chimneys, particularly in windy or similar conditions where they can flex, flexible plastic bags have the potential to build up significant static electricity within the “tube”, which could lead to a spark, potentially igniting the vapors in the chimney and then in the tank, causing an extremely hazardous fire or explosion.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein are, among other things, a system for exhausting vapor from a tank, the system comprising: a pipe connector, for connecting to a tank from which vapor is to be removed; a blower, connected to the pipe connector at a first end of the blower, and having a second end including a bell connector; and a rigid extension, having a spigot at a first end thereof, the spigot being connected to the bell connector; wherein, the system stands at least 12 feet tall when fully assembled onto the tank.

In an embodiment of the system the rigid extension comprises metal, the blower and pipe connector comprise metal, the system provides electrical continuity along its length and there is further included a ground lead which serves to electrically ground the system.

In an embodiment of the system the blower, which may be an eductor, is connected to the pipe connector via interconnecting flanges.

In another embodiment, the bell connector and the spigot are further connected by a clamp which may provide electrical continuity between the spigot and the bell connector.

There is also described herein, a system for exhausting vapor from a tank, the system comprising: means for pulling vapor from the tank, the means for pulling being connected to a tank at a first end, and having a second end opposing the first end; a rigid extension; and means for attaching the rigid extension to the means for pulling vapor at the second end thereof; wherein, the system stands at least 12 feet tall when fully assembled onto the tank.

In an embodiment of the system, the rigid extension comprises metal, the means for connecting and the means for pulling comprises metal, the system provides electrical continuity along its length, and the system further includes a means for connecting the system to an electrical ground.

In another embodiment of the system, the means for pulling, which may be an eductor, is connected to the means for connecting via interconnecting flanges.

In another embodiment of the system the means for attaching comprises a bell and spigot joint which may further include a clamp which may provide electrical continuity between the spigot and the bell connector.

There is also described herein, a method for exhausting vapor from a tank, the method comprising: connecting a blower formed of metal to a tank from which vapor is to be removed; providing a rigid extension having a first end and a second end; and attaching the rigid extension to the blower at the first end, the attachment comprising a bell and spigot connection, wherein, the second end of the rigid extension is located at least 12 feet above ground level after the attaching.

### BRIEF DESCRIPTION OF THE DRAWINGS

FIG. 1 shows a partially exploded view of the components of an embodiment of a blower exhaust stack.

FIG. 2 shows a an embodiment of an exhaust stack attached to an underground tank access.

### DESCRIPTION OF THE PREFERRED EMBODIMENT(S)

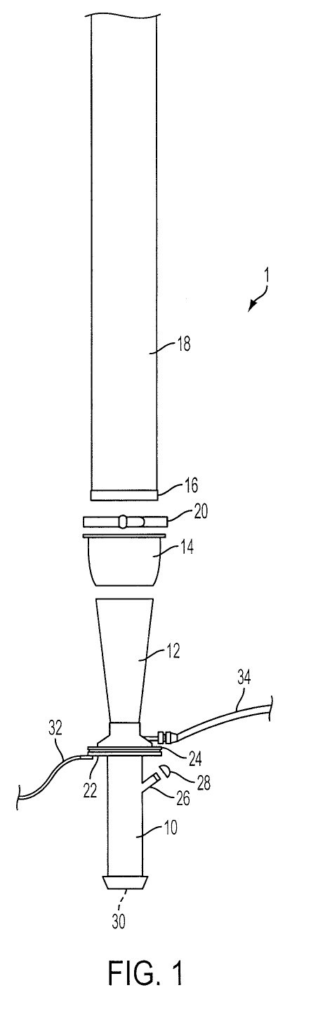

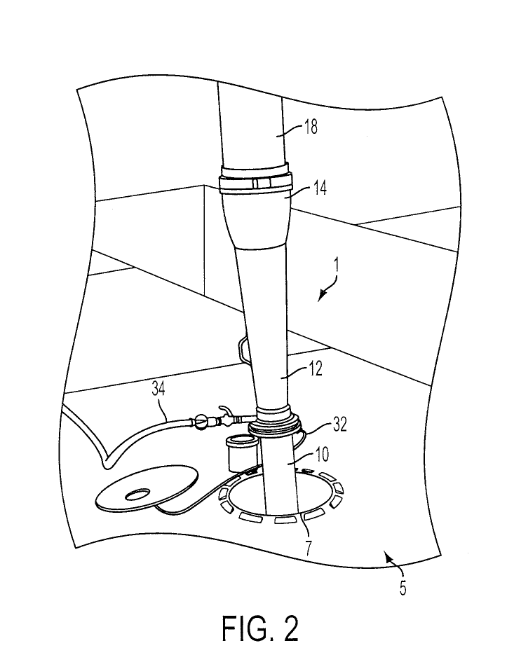

The following detailed description illustrates by way of example and not by way of limitation. Described herein, among other things, is an embodiment of system (1) and the associated method for exhausting vapors from a tank (5). This is sometimes referred to as an exhaust stack (1). These embodiments are discussed specifically in combination with FIGS. 1 and 2. In these embodiments, the stack (1) comprises a flanged pipe adapter (10), an air blower (12), a bell adapter (14) connected to the top of the blower (12), an exhaust extension (18), and a spigot adapter (16) connected to one end of the exhaust extension (18). The bell adapter (14) and the spigot adapter (16) being designed to be coupled in a bell and spigot coupling or joint. In the depicted embodiments, the bell and spigot coupling may be supported by a coupling band clamp (20) to provide further stability to the stack (1).

In an embodiment, the flanged pipe adapter (10) is a four inch diameter cast iron pipe incorporating a pipe flange (22) on a first end for mating with a blower flange (24). In an embodiment, the pipe flange (22) is connected to a ground lead (32) comprising an electrical lead connected to electrical ground to prevent the buildup of static electricity in the system (1) which could potentially cause a spark. This can be a wire or similar means for such connection as understood by those of ordinary skill. In an embodiment, the pipe adapter (10) also includes a port extension (26) comprising a smaller diameter pipe joined at a Y-joint. In an embodiment, this port extension (26) is a one inch diameter pipe port. This port extension (26) can be used to access the interior of the tank (5) being evacuated of vapor while the stack (1) is in place, so that vapor concentrations in the tank (5) can be measured by use of a probe inserted into the tank (5) through such port extension (26). When not utilizing the port extension (26), it can be sealed by a cap (28), for example, a one inch threaded pipe cap. In an embodiment, the pipe adapter (10) is provided with pipe threads (30) on a second end, either male or female, that can be mated with threads on an access point (7) of the tank (5) to attach the pipe adapter (10) to the tank (5) or mated with threads on a riser pipe that is typically connected to the tank (5) in emptying and vapor freeing operations.

In an embodiment, the air blower (12) is attached via the pipe flange (22) to the upper portion of the pipe adapter (10). The blower (12) may be any form of commercial blower but generally is a Venturi-style pneumatic air blower, also known as an air horn or eductor, such as, but not limited to, those sold commercially by Air Systems International, Inc., Chesapeake, Va., among others. Such an eductor (12) is preferred as it generally does not expose any electrical parts of the blower (12) to the vapor stream as such electrical current could generate a spark or ignite the vapor. Still further, an eductor (12) does not have moving mechanical parts, such as a turbine or fan, in the vapor stream which could generate sparks. The air blower (12) is generally operated through connection to a source of pressurized air, such as air hose (34). The pressurized air is forced into the eductor (12) and directed through the Venturi nozzle of the eductor (12) (which is upwards in FIG. 1). Due to the Venturi effect, the passage of the pressurized air in the blower (12), creates a neighboring vacuum which serves to pull air from the pipe adapter (10) and ultimately the tank (5) via the access point (7). That air is then mixed with the pressurized air and directed upward in the Venturi nozzle.

While commercially available eductors (12) typically include a mounting system at the bottom, such as a blower flange (24) designed to interface with the pipe flange (22), they generally do not include a mounting system at the top thereof. It, therefore, has traditionally been difficult to attach any type of extended exhausts to the top of the eductor (12) and therefore prior exhaust stacks have generally been limited by the height of the eductor (12).

In part for the purpose of increasing the height of the eductor (12) exhaust, a coupling adapter (14), which in the depicted embodiment comprises a bell adapter (14), is connected thereto, allowing an exhaust extension (18) to be connected to the eductor (12) in a straightforward fashion. This allows for increase in the height of the exhaust stack (1) by forming a chimney for the blower (12) which is easily transported and attached, and which eliminates many of the problems of make-shift devices.

In an embodiment, the coupling adapter (14) is a steel bell adapter (14). The bell adapter (14) will generally be welded or otherwise attached in a solid fashion to the top of the eductor (12), which, in an embodiment, is also of steel or other metal construction. In an embodiment, the bell adapter (14) is sized to receive an eight inch diameter pipe or tube therein in a standard bell and spigot joint. To do so, the bell adapter (14) may provide an increase, a decrease, or both an increase and decrease in diameter from that of the top of the eductor (12). Generally, there will be an increase in diameter to provide for a bell capable of mating with an about 8 inch diameter extension (18).

Attached to the bell adapter (14) and above the blower (12)is an exhaust extension (18) or “chimney.” The extension (18) serves to provide a pathway through which the vapor can pass before being exhausted. The extension (18), therefore, serves to extend the point of the exhaust of the blower (12) into ambient air by the length of the extension (18). Therefore, with the inclusion of a chimney of sufficient length (generally about 7 feet or more), the exhaust stack (1) can be extended from a height of 3-4 feet to a height of 12 feet or more to comply with applicable regulations. The extension (18) is also preferably of rigid construction so as to support its own weight even when no air or vapor is passing through the extension (18). In this way, the height of the stack (1) is generally known and fixed and is not as effected by environmental conditions such as wind or operation of the blower (12). Further, being of rigid construction, parts of the extension (18) will generally not interact with each other in such a way to provide friction or electrical buildup.

In an embodiment, for purposes of providing a good coupling between the eductor (12) and the exhaust extension (18) a spigot adapter (16) is provided on one end of the extension (18). The spigot adapter (16) may be of the same material construction as is the bell adapter (14). In a preferred embodiment, both of the bell adapter (14) and the spigot adapter (16) are of a steel construction.

In an embodiment, the spigot adapter (16) is pressure fit onto the end of the exhaust extension (18). In such a case, the spigot adapter (16) may have a slightly larger outer diameter than the inner diameter of the exhaust extension (18). In a preferred embodiment, the exhaust extension (18) is constructed of a material that allows for sufficient expansion such that a spigot adapter (16) of slightly larger diameter can be fit within the inner diameter thereof. In a preferred embodiment, the exhaust extension (18) is constructed of aluminum and has an about eight inch diameter. Also, in a preferred embodiment, the exhaust extension (18), when connected to an eductor (12) that is, in turn, connected to a storage tank (5), rises to at least twelve feet above the ground or to another height dictated by applicable regulations. In an embodiment, the exhaust extension (18) is at least seven feet long.

It should be recognized that the use of a bell and spigot joint between the extension (18) and blower (12) is not the only type of connection which may be used and in other embodiments different types of couplings may be used. For example, in an alternative embodiment, the extension (18) may be attached by screws or bolts placed through an adapter (14) attached to the blower (12) and then either engaged to the extension (18) by friction or by being threaded into mating holes in the extension (18). In a still further embodiment, the extension (18) may be directly welded to the blower (12), however, this is generally less preferred as it makes the stack (1) unable to break down into smaller pieces. Still further, other couplers, such as sleeve type couplers or retaining clamps may be used to form the connection between the extension (18) and the blower (12). Further, even if a bell and spigot type of coupler is used to connect the extension (18) and blower (12), the location of the bell and spigot may be reversed having the bell on the extension (18) and the spigot on the blower (12), or may be modified from those shown to provide for the desired connection.

As described above, in an embodiment, the assembled apparatus is predominantly or entirely made of metal components (both steel and aluminum) that have secure joints one to the other that are generally also constructed of metal. Thus, in such an embodiment, the assembled exhaust stack provides electrical continuity along its entire length by being a secure metallic construction. Having such continuity, only one component of the stack (1) needs to be grounded to ensure that the entire stack (1) is grounded, and thus does not develop an electric charge along its length that could discharge with a spark, dangerously igniting vapors from the tank (5). This connection can be provided by ground connection (32) which is easily attached to a lower section of the stack (1) and then connected to electrical ground.

In an embodiment, to further insure electrical continuity and to potentially also provide for improved latitudinal strength, the bell (14) and spigot (16) joint includes a clamp (20) to further connect the bell (14) to the spigot (16). In an embodiment, the clamp (20) secures the spigot adapter (16) to the exhaust extension (18). In an alternate embodiment, the clamp (20) secures the bell (14) and spigot (16) joint itself providing for a stronger and more robust connection.

In an embodiment, the several components are assembled in the field, where a storage tank (5) is located that needs to be vapor freed. This allows the stack (1) to be broken down into smaller sections for easier transport and to be assembled as needed for vapor freeing. Generally when assembled in the field, the pipe adapter (10) is first connected to the tank (5) via the access point (7). The eductor (12) having the bell adapter (14) previously attached thereto is then connected to the pipe adapter (10), generally at the top thereof. The exhaust extension (18) having a spigot adapter (16) previously connected thereto is inserted into the bell adapter (14) and secured with the clamp (20), if appropriate, to the top of the blower (12). The ground lead (32) and pressurized air source (34) are connected at appropriate times during this assembly.

There is therefore created a system (1) which serves to exhaust the vapors in the tank (5) at a safer elevation by creating an essentially continuous pathway from the tank (5), through the blower (12) and up the extension (18). This stack (1) preferably presents an exhaust point at the distal end of the extension (18) which is at least 12 feet in the air. Once fully assembled, the system (1) is operated to remove vapors from inside the tank (5). As the resultant construction is ideally greater than 12 feet tall, the vapors exhausted are exhausted at the necessary height to comply with regulations. Further, as the device (1) is grounded by the ground lead (32) and forms a continuous electrical circuit with itself, the risk of spark created by a buildup of static electricity is greatly reduced making the system (1) safer than make-shift devices.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A system for exhausting vapor from a tank, the system comprising:
a pipe connector, for connecting to a tank from which vapor is to be removed;
a blower, connected to said pipe connector at a first end of said blower, and having a second end including a bell connector; and
a rigid extension, having a spigot at a first end thereof, said spigot being connected to said bell connector;
wherein, said system stands at least 12 feet tall when fully assembled onto said tank.

2. The system of claim 1 wherein said rigid extension comprises metal.

3. The system of claim 2 wherein said blower and said pipe connector comprise metal.

4. The system of claim 3 wherein said system provides electrical continuity along its length.

5. The system of claim 4 wherein said system further includes a ground lead which serves to electrically ground said system.

6. The system of claim 1 wherein said blower is connected to said pipe connector via interconnecting flanges.

7. The system of claim 1 wherein said bell connector and said spigot are further connected by a clamp.

8. The system of claim 7 wherein said clamp provides electrical continuity between said spigot and said bell connector.

9. The system of claim 1 wherein said blower comprises an eductor.

10. A system for exhausting vapor from a tank, the system comprising:
means for pulling vapor from said tank, said means for pulling being connected to a tank at a first end, and having a second end opposing said first end;
a rigid extension; and
means for attaching said rigid extension to said means for pulling vapor at said second end thereof;
wherein, said system stands at least 12 feet tall when fully assembled onto said tank.

11. The system of claim 10 wherein said rigid extension comprises metal.

12. The system of claim 11 wherein said means for connecting and said means for pulling comprises metal.

13. The system of claim 12 wherein said system provides electrical continuity along its length.

14. The system of claim 13 wherein said system further includes a means for connecting said system to an electrical ground.

15. The system of claim 10 wherein said means for pulling is connected to said means for connecting via interconnecting flanges.

16. The system of claim 10 wherein said means for attaching comprises a bell and spigot joint.

17. The system of claim 16 wherein said means for attaching further includes a clamp.

18. The system of claim 17 wherein said clamp provides electrical continuity between said spigot and said bell connector.

19. The system of claim 10 wherein said means for pulling comprises an eductor.

20. A method for exhausting vapor from a tank, the method comprising:
connecting a blower formed of metal to a tank from which vapor is to be removed;
providing a rigid extension having a first end and a second end; and
attaching said rigid extension to said blower at said first end, said attachment comprising a bell and spigot connection;
wherein, said second end of said rigid extension is located at least 12 feet above ground level after said attaching.
